(19) United States
(12) Patent Application Publication
(10) Pub. No.: US 2014/0054899 A1
(43) Pub. Date: Feb. 27, 2014

(54) CENTRIFUGE

(71) Applicant: Haim Morgenstein, Beit-Arie (IL)

(72) Inventor: Haim Morgenstein, Beit-Arie (IL)

(73) Assignee: Green Gold 2007 Ltd, Haifa (IL)

(21) Appl. No.: 14/112,116

(22) PCT Filed: Apr. 5, 2012
(86) PCT No.: PCT/IL12/00155

§ 371 Date: Oct. 16, 2013

(30) Foreign Application Priority Data
Apr. 17, 2011 (IL) 212441

(51) Int. Cl. H02K 7/18

(52) U.S. Cl. CPC H02K 7/18
USPC 290/1 A; 241/101.2

(57) ABSTRACT

The invention is a method and a centrifuge for neutralizing hysteresis forces that hold magnetic particles of a magnetic fluid together in the form of bullets in a closed-circuit energy converter for converting thermal energy into alternating current electrical energy and for preventing damage to components or operation of the energy converter caused by the bullets.

### FIELD OF THE INVENTION

The present invention relates to the field of energy production. More particularly, the present invention relates to a component of an energy converter unit (hereinafter sometimes simply ‘converter’) for converting thermal energy into electrical energy.

### BACKGROUND OF THE INVENTION

In U.S. Pat. No. 7,745,962 the inventor of the present invention describes a thermal to electrical energy converter based on the use of ferrofluids. Ferrofluids, which have the fluid properties of a liquid and the magnetic properties of a solid, contain tiny particles of a magnetic solid suspended in a liquid medium. A ferrofluid is a stable colloidal suspension of sub-domain magnetic particles in a liquid carrier. The particles, which have an average size of about 100 Å(10 nm), are coated with a stabilizing dispersing agent (surfactant). A typical ferrofluid may contain (by volume) 5% magnetic solid, 10% surfactant and 85% carrier (liquid).

In international patent application WO2008/010202 the inventor of the present invention describes the thermal to electrical energy converter of U.S. Pat. No. 7,745,962 in which the ferrofluid is replaced by a Magneto-Rheological Suspension (MRS) also known as a Magneto-Rheological Fluid (MRF). MRSs are suspensions of particles (usually iron or nickel) grains whose diameter d˜5 to 10 μm which is about 500 to 1000 times the diameter of magnetic grains used in ferrofluids. These course magnetic grains are used in practice for polishing, visualization of domain boundaries, in magnetic clutches, braking mechanisms, etc. The technical applications of MRSs are based on their property of congealing under the influence of a magnetic field. In contrast to sub-domain magnetic grains of ferrofluids the large particles of a MRS do not possess their own magnetic moments, but they are easily magnetized in an external magnetic field. The magnetic permeability of multi-domain iron or nickel particles is μ˜10⁴.

In both cases heat is converted to electricity by continually pushing the magnetic fluid (magnetic fluid is a generic term defined herein for either a ferrofluid, MRS or both) around a closed circuit energy converter by pulses of gas. At selected locations there is a uniform magnetic field to align the magnetic moments of the magnetic particles, at the same location where the magnetic field is located, the conduit through which the magnetic fluid pulses move is surrounded by a coil of wire in which an AC electric current is induced.

During the process of developing a working converter, the inventor has discovered that the efficiency is affected by an unexpected phenomenon. For maximum efficiency, the magnetic particles, which are attracted to each other by their magnetic moments (either intrinsic or induced) as they pass through the uniform magnetic field and coil of wire in which the electric current is induced, must immediately separate from each other and revert to magnetic fluid in order to be able to continue on the rest of their journey around the closed circuit of the converter. It might be expected that the separation of the particles from the state of forming a close bundle held together by their mutual magnetic attraction to a dispersed state suspended in a liquid carrier would be essentially instantaneous. However in practice, because of hysteresis effects, the separation takes place relatively slowly in terms of the speed at which the particles move around the circuit of the converter.

It is therefore a purpose of the present invention to provide a device that is introduced into the circuit of the converter in order to overcome the hysteresis effects that hold the magnetic particles together.

Further purposes and advantages of this invention will appear as the description proceeds.

### SUMMARY OF THE INVENTION

Herein the following definitions are used:
A “magnetic fluid” is a liquid suspension of particles made of a material that either has an intrinsic magnetic moment or in which a magnetic moment can be induced.
“Magnetic particles” are the solid component, i.e. the particles, in a magnetic fluid.
“Vapor” is the gas phase of the liquid component of a magnetic fluid.
A “ferrofluid” is a magnetic fluid in which the particles have an intrinsic magnetic moment.
A “magnetorheological suspension” (MRS) or a “magnetorheological fluids” (MRF) is a magnetic fluid in which the particles do not posses their own magnetic moment but are easily magnetized in an external magnetic field.
A “ferromixture” is the working substance of the energy converter of the invention. It is a mixture which comprises some or all of the following: magnetic fluid, a carrier gas, vapors, and magnetic particles. The exact instantaneous composition of the ferromixture at any location in the converter depends on the instantaneous temperature and pressure at that location.
A “cloud” is a short burst of ferromixture that is created by the opening of a valve between a high pressure region in the converter and a lower pressure region. The cloud is propelled around the converter by the controlled differences in pressure created at predetermined times and predetermined locations in the dosed loop of the converter. In the hot-to-cold part of the converter the cloud is primarily comprised of magnetic particles dispersed in carrier gas and vapor, all of which are ejected from the HAC (Heat Absorbing Container of the converter). In the cold-to-hot part of the converter the cloud is primarily comprised of magnetic fluid pushed out of the HDC (Heat Dissipating Container of the converter) by carrier gas.
A “bullet” is a spatially discrete group of magnetic particles that are formed when moving through a uniform magnetic field. The magnetic field induces the magnetic moment in a MRS, aligns the magnetic moments of the particles, and causes them to bunch together.

In a first aspect the invention is a centrifuge for neutralizing hysteresis forces that hold magnetic particles of a magnetic fluid together in the form of bullets in a closed-circuit energy converter for converting thermal energy into alternating current electrical energy and for preventing damage to components or operation of the energy converter caused by the bullets.

The energy converter in which the centrifuge of the invention operates comprises the following sections:
(i) a section wherein the magnetic fluid is decomposed into ferromixture comprising magnetic particles and gaseous components;
(ii) a section wherein the magnetic moments of the magnetic particles are aligned forming the magnetic particles into bullets that pass through coils of wire in which electricity is induced;
(iii) a section wherein the bullets are broken apart into individual magnetic particles having randomly oriented magnetic moments; and
(iv) a section wherein the magnetic fluid is recomposed from the magnetic particles and condensed gaseous components.

The centrifuge is adapted to be connected to a conduit in section (iii) of the energy converter and comprises:
(i) an upper manifold connected to the conduit of the energy converter;
(ii) a lower manifold;
(iii) at least one shunt and a section of straight conduit providing paths for components of ferromixture to travel from the upper manifold to the lower manifold; and
(iv) a large diameter tube having first and second ends, the first end connected to the bottom of the lower manifold and the second end connected to an endpiece, the endpiece having a truncated conical shape, a plurality of perforations in its wall, and an open distal end.

In embodiments of the centrifuge of the invention the ends of the at least one shunt enter the lower manifold off-center and at an angle. Embodiments of the centrifuge comprise a mechanism for changing the angle while the energy converter is working.

Embodiments of the centrifuge comprise at least one wire coil wrapped around the large diameter tube and connected to an electric circuit comprising a resistive load.

In a second aspect the invention is a method for neutralizing hysteresis forces that hold magnetic particles of a magnetic fluid together in the form of bullets in a closed-circuit energy converter for converting thermal energy into alternating current electrical energy and for preventing damage to components or operation of the energy converter caused by the bullets.

The energy converter comprises the following sections:
(i) a section wherein the magnetic fluid is decomposed into ferromixture comprising magnetic particles and gaseous components;
(ii) a section wherein the magnetic moments of the magnetic particles are aligned forming the magnetic particles into bullets that pass through coils of wire in which electricity is induced;
(iii) a section wherein the bullets are broken apart into individual magnetic particles having randomly oriented magnetic moments; and
(iv) a section wherein the magnetic fluid is recomposed from the magnetic particles and condensed gaseous components.

The method comprises:
(a) connecting a centrifuge to a conduit in section (iii) of the energy converter; the centrifuge comprising:
   (i) an upper manifold connected to the conduit of the energy converter;
   (ii) a lower manifold;
   (iii) at least one shunt and a section of straight conduit providing paths for components of ferromixture to travel from the upper manifold to the lower manifold; and
   (iv) a large diameter tube having first and second ends, the first end connected to the bottom of the lower manifold and the second end connected to an endpiece, the endpiece having a truncated conical shape, a plurality of perforations in its wall, and an open distal end;
(b) causing a first part of the gaseous components of the ferromixture to flow from the upper manifold to the lower manifold through the at least one shunt;
(c) causing a second part of the gaseous components of the ferromixture and the bullets comprised of magnetic particles to flow from the upper manifold to the lower manifold through the section of straight conduit;
(d) adapting the lower manifold such that gas flowing through the at least one shunt impacts the sides of the bullets as they exit the section of straight conduit and pass through the center of the lower manifold, thereby imparting forces that act to cause the bullets to spin; and
(e) allowing the spinning bullets to continue to travel through the large diameter tube wherein the centrifugal forces on the spinning overcome the hysteresis forces that hold the magnetic particles together, thereby breaking apart the bullets.

In embodiments of the method of the invention the adapting step (d) comprises causing the ends of the at least one shunt enter the lower manifold off-center and at an angle. In embodiments of the method the angle is changed while the energy converter is working.

Embodiments of the method of the invention comprise wrapping at least one wire coil around the large diameter tube and connecting the coil to an electric circuit comprising a resistive load.

Embodiments of the method of the invention comprise:
(f) blocking or removing the straight section of conduit between the upper and lower manifolds of the centrifuge;
(g) replacing steps (b) and (c) with the step of causing the gaseous components of the ferromixture and the bullets comprised of magnetic particles to flow from the upper manifold to the lower manifold through the at least one shunt; and
(h) replacing step (d) with the step of adapting the lower manifold such that gas and bullets flowing through the at least one shunt enter the lower manifold off-center and at an angle thereby imparting forces that act to cause the bullets to spin as they enter the large diameter tube.

Other embodiments of the method of the invention comprise:
(f) blocking or removing the at least one shunt between the upper and lower manifolds of the centrifuge;
(g) replacing the straight section of conduit between the upper and lower manifolds of the centrifuge with a section of tubing bent into a spiral shape;
(h) replacing steps (b), (c), and (d) with the step of causing the gaseous components of the ferromixture and the bullets comprised of magnetic particles to flow from the upper manifold to the lower manifold through the spiral shaped section of tube thereby imparting forces that act to cause the bullets to spin as they enter the large diameter tube.

In a third aspect the invention is an energy converter based on causing a magnetic fluid to travel around a closed circuit for converting thermal energy into alternating current electrical energy, the energy converter comprising at least one centrifuge adapted to neutralize hysteresis forces that hold magnetic particles in the magnetic fluid together in the form of bullets, thereby insuring efficient operation of the energy converter and preventing damage to components of the energy converter caused by the bullets,

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 schematically illustrates the general layout and functionality of the prior art converter;

FIG. 2 and FIG. 3 schematically show the centrifuge of the present invention; and

FIG. 4 is a cross sectional view showing the interior of the manifold at which the bullets are caused to spin.

### DETAILED DESCRIPTION OF EMBODIMENTS OF THE INVENTION

The energy converter that is the subject matter of U.S. Pat. No. 7,745,962 and WO2008/010202 is basically a closed loop device containing a medium that is capable of absorbing heat from an external heat source in a high temperature reservoir and producing AC electricity while delivering a portion of the heat to a cold temperature reservoir and then returning the medium to the high temperature reservoir. The converter comprises two half cycles—the first from a hot location to a colder one and the second from cold to hot—that are connected to form a complete cycle. This arrangement is a Carnot cycle having a very high efficiency of energy conversion. The external heat source, which provides the required heat to the converter, can be essentially any heat source. For example, the heat can be provided by the residual heat from a nuclear power station, from an air condition system, from a compressor, from any operating engine, or from a motor. In one embodiment the heat source is solar radiation and in another embodiment the heat source is a vehicle engine. In contrast to conventional industrial power plants, the system does not use energy consuming machinery such as compressors, turbines or pumps. The working substance of the energy converter of the invention is a ferromixture, which replaces superheated steam that is usually utilized in conventional power plants to drive a turbine.

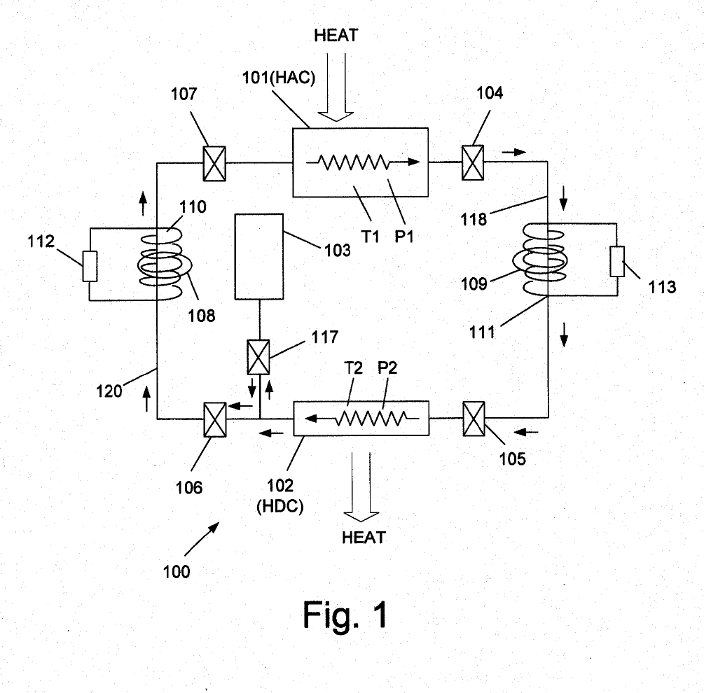

The energy converter consists in its most basic embodiment (shown schematically in FIG. 1) of two chambers connected in series by conduits. The magnetic fluid coexists together with its vapor in a large chamber, called herein the Heat Absorbing Container (HAC), in which heat is absorbed from the external source. In order to control the boiling temperature of the magnetic fluid, a non-reacting carrier gas is inserted into the chamber. Air, for example, can not be used as the carrier gas because it will cause oxidation of the magnetic particles. Examples of an appropriate choice are mixtures of nitrogen and alcohol or nitrogen and distilled water. When the temperature and pressure inside the HAC reach predetermined values a valve is momentarily opened to release a cloud of hot ferromixture from the HAC into the outlet conduit. By proper synchronization of the valves in the converter, as will be described herein below, a valve ahead of the cloud will be kept closed, thereby causing the pressure on the leading edge of the cloud to increase causing the cloud to have a smaller volume and more sharply defined shape as it travels through the conduit. As the cloud of ferromixture is propelled around the closed-loop converter, it encounters a section of the conduit that is surrounded by a uniform magnetic field and a coil of electric wire. If the magnetic fluid is a MRS, the uniform magnetic field induces a magnetic moment in the particles and aligns them with respect to the direction of the field. In the case of ferrofluid, the magnetic field aligns the permanent magnetic moments of the particles. In both cases the magnetic field forms the magnetic particles in the cloud into closely spaced groups of particles called bullets. The aligned magnetic moments of the particles in the bullets produce an alternating electric current in the coil of electrical wire as they are propelled through this section of conduit. After passing through the region surrounded by the magnetic field, the alignment of the magnetic moments generally becomes random in a ferrofluid; however it has been found by the inventor that hysteresis effects keep the particles of an MRS together necessitating the introduction of means to break up the bullet. These means are the subject matter of the present invention and are described herein below. After the magnetic particles are separated from each other, the ferromixture is pushed and sucked into a Heat Dissipating Chamber (HDC) in which the vapor condenses until the ferromixture comprises magnetic particles in suspended in the liquid, i.e. reconstituted magnetic fluid, and carrier gas at low pressure and temperature. A quantity of magnetic fluid is then pushed by the carrier gas out of the HDC into the inlet conduit by the hotter ferromixture entering the HDC and returns to the main heating chamber, optionally passing through a conduit that has another coil of electric wire and uniform magnetic field surrounding it, thereby producing more electricity.

The converter utilizes the temperature differences between the HAC and the HDC and careful design of the dimensions of the outlet and inlet conduits to exploit known phenomena connected with the pressure and temperature changes that take place in fluids flowing through conduits having variable inner diameters to cause changes in the pressure and temperature of the ferromixture. This together with proper timing of the opening and closing of the valves in the circuit create waves of pressure that push the clouds of ferromixture around the converter.

FIG. 1 schematically illustrates a simplified embodiment of the converter, in order to describe the general layout and principle of operation of the converter. The small arrows placed next to the conduits indicate the direction of flow of the magnetic particles through the conduits. Initially, i.e. at the assembly/installation stage, the HAC 101, HDC 102, and the conduits that connect them to form the closed-loop system, are partially filled with magnetic fluid and carrier gas in a ratio that is appropriate to prevent the pressure in the HAC from rising above dangerous levels. The exact ratio depends, among other factures, on the maximum temperature of the external heat source, the material of which the converter is built, and of the type of magnetic fluid. An appropriate ratio of magnetic fluid to carrier gas for most situations is thought to be about 1:4, but this ratio can be changed if necessary.

At the “start” of a cycle, HAC 101 inlet and outlet valves 107 and 104, respectively, HDC 102 inlet and outlet valves 105 and 106, respectively, and valve 117 are all in the “closed” state. Initially, if the temperature of the external heat source is not high enough, the pressure of the carrier gas in the HDC is lower than atmospheric pressure, to allow boiling of the liquid component of the magnetic fluid at lower temperatures than would have been possible at atmospheric pressure. In other cases, if the temperature of the heat source is very high, it may be necessary to make the pressure of the carrier greater than atmospheric pressure to maintain proper operating conditions in the converter. Alternatively the start up problem can be overcome by using carrier gas having a lower boiling point. HAC 101 and the magnetic fluid and carrier gas in it absorb heat from an external source, such as the sun, to heat the magnetic fluid and gas to a first temperature (T1), and, at the same time, HDC 102 dissipates heat to an external heat sink, cooling the ferromixture contained therein to a second temperature (T2), lower than T1 in order to cause the vapor to return to its liquid state.

As HAC 101 absorbs heat from the external heat source, the temperature T1 of the magnetic fluid contained therein starts to increase causing the liquid portion of the magnetic fluid to vaporize and the total pressure inside HAC 101 (P1) to increase. At the same time, the ferromixture is cooled in HDC 102 to T2 causing the vapor present in the ferromixture to condense and the pressure inside HDC 102 (P2) to decrease. In other words, the difference between the first and the second temperatures is translated into a corresponding difference in the pressure inside HAC 101 and HDC 102. The difference between these pressures is the force that will cause the magnetic particles to advance as a wave circulating around the closed-loop converter as described herein below. The actual maximum and minimum values of P1, P2, T1, and T2 that will result in safe operation and maximum efficiency of the converter of the invention have to be determined for each specific embodiment of the converter. These values depend, upon many other factors, on the materials of which the various parts of the reactor are built, wall thickness, etc. For example, if the HAC is made of non-reinforced glass, it is recommended to not allow P1 to exceed approximately three atmospheres.

When the pressure difference (P1-P2) reaches some predetermined value, valve 104 is opened to initiate the first half of the cycle by releasing a cloud of ferromixture comprising carrier gas, vapor, magnetic particles, and possible a small proportion of droplets of magnetic fluid into outlet conduit 118. Valve 105 can be opened essentially simultaneously with valve 104, but it is normally preferred to open valve 105 after a short delay in order to allow the pressure inside conduit 118 to build up in front of the cloud, thereby confining the cloud to a relatively small volume within the conduit. As soon as valve 105 is opened the pressure in conduit 118 is lower than the pressure in HAC 101 and the cloud is “pushed” by the higher pressure on one side and “pulled” by the lower pressure on the other side. i.e. is propelled along conduit 118 from HAC 101 in the direction of HDC 102. As the cloud is ejected from the HAC, the pressure P1 and the temperature (T1) inside HAC 101 decrease. When valve 105 is opened, the cloud pushes the (colder) magnetic fluid and carrier gas that were originally present in conduit 118 and in HDC 102 in the direction of closed valves 106 and 117. The cloud of ferromixture pushing against the ferromixture near the entrance to the HDC 102 compresses it causing the pressure (P2) in HDC 102 to rise. As the ferromixture is compressed and as the temperature of the part of the cloud that has reached the HDC 102 is lowered, the vapor condenses until the ferromixture near the outlet side of the HDC 102 comprises only magnetic fluid and carrier gas.

When P2 reaches its maximum value, valves 104 and 105 are closed, to complete the first half of the cycle. Then, valves 106 and 107 are opened. For a brief time P2 is greater than P1 and the over-pressure of the carrier gas in HDC 102 relative to the pressure in conduit 120 and HAC 101, pushes the magnetic fluid that has collected at the end of HDC 102 closest to valve 106 through valve 106, conduit 120, and valve 107 into HAC 101. When the pressure in HAC 101 equals that in HDC 102 valves 106 and 107 are closed, thereby completing the second half of the cycle.

Now, the next cycle begins, wherein: (1) HAC 101 absorbs external heat to raise the temperature of the (now) cold magnetic fluid contained therein to the first temperature T1 and pressure P1 at which part of the liquid component of the magnetic fluid is in its vapor state, and (2) HDC 102 dissipates heat to the heat sink, lowering the temperature of the (now) hot carrier gas, vapor, and magnetic fluid contained therein to the second temperature T2 and pressure P2 at which most of vapor condenses, and (3) operating valves 104 to 107 as described in connection with the first cycle described hereinabove. One cycle will follow another cycle with a portion of the magnetic fluid being exchanged between HAC 101 and HDC 102 at each cycle, unless converter 100 malfunctions or it is necessary for some reason to halt the operation of the converter. In this manner, a substantially continuous train of bullets is produced and propelled through conduit 118. This flow is utilized to induce an alternating electric current in a coil of electric wire.

Electricity conducting wires 110 and 111 are coiled around conduits 120 and 118, respectively. Magnetic fluid or magnetic particles flowing through these conduits should induce electric currents in wires 110 and 111, which are connected to loads 112 and 113. However, since the particles suspended in the magnetic fluid and the magnetic particles either have no intrinsic magnetic moment or their magnetic moments are aligned randomly (with respect to one another) in their carrier (whether a liquid or a gas, depending on the location in the converter and on the stage of the cycle), the net magnetic field of the particles is zero. Under such circumstances no current will be induced in electric wires 110 and 111. In order to produce electric current, the magnetic dipoles must be induced, if necessary, and aligned in such a way as to produce a non-zero net magnetic field moving through the coiled electric wires (110 and 111). This alignment is implemented by the use of permanent magnets 108 and 109 which are located so as to generate a constant magnetic field at sections of the closed-loop converter surrounded by the coils of wire and through which the bullets of ferromixture pass. It is to be understood, that the coils of wire 110 and 111 are shown symbolically only and can represent, for example a plurality of coils connected in series or any other arrangement suitable to meet the requirements of the invention. Similarly the alignment magnets 108 and 109 are shown symbolically only and can represent, for example a plurality of ring-shaped magnets, bar magnets, or any other arrangement known in the art for creating a uniform magnetic field in a given region. Also, there can be more than one electricity producing region located along the length of each of the conduits 118 and 120. It is also to be noted that the coils 110 and associated magnets are optional and need not be present in every embodiment of the converter. Additionally, after passing through coils 110 the hysteresis effects are smaller than after coils 111 and the bullets are heading towards the hotter part of the converter; therefore a centrifuge might not be needed after coils 110 as opposed to coils 111, which in most cases will have to be followed by a centrifuge.

Magnets 108 and 109 are shown encircling conduits 118 and 120 in order to generate magnetic fields that will induce magnetic moments in the magnetic particles of a MRS and will align the magnetic moments of the magnetic particles, such that their longitudinal axis substantially coincides with the longitudinal axis of the conduits. In this way, the flow of the magnetic particles will produce a local non-zero magnetic field that induces an electric current in electric wires 110 and 111. If a continuous stream of aligned magnetic dipoles flows through the induction coil the net electrical output will be zero. Therefore the dipoles are arranged into discrete bullets that will generate pulses of alternating electric current. In order to insure that the magnetic moments have been induced in time and to form the bullets out of the particles that are randomly distributed through out the cloud of ferromixture, some of the magnets may be located around the conduit upstream of the induction coil. If only a single high energy bullet is formed, then all of the energy may not be dissipated when it passes through coil 111, thus a number of spaced apart coils can be positioned around conduit 118 in order for a plurality of pulses to be produced by a single bullet. Alternatively, a number of spaced apart ring magnets can be used to form a series of lower energy bullets from a single ferromixture cloud. As previously noted, the formation of the bullets can also be at least partially accomplished by proper synchronization of the opening and closing of valves 104 and 105 to form clouds that have a very small volume.

In order to further control the operating conditions within the converter, a reservoir container 103 is provided. The description and operation of reservoir container 103 is not relevant to the present invention. They are fully described in U.S. Pat. No. 7,745,962 and WO2008/010202.

After passing through the region surrounded by the magnetic field, the alignment of the magnetic moments becomes random in a ferrofluid and ferromixture containing ferrofluid is pushed and sucked into a Heat Dissipating Chamber (HDC). In the case of ferromixtures containing MRS means to neutralize the hysteresis effects that continue to hold the bullet together must be added to the converter at this location. Inside the HDC, after the magnet forces that held the bullet together have been sufficiently weakened to allow the magnetic particles (in both a ferrofluid and a MRS) to separate, the vapor condenses until the ferromixture comprises magnetic particles in the liquid suspension, i.e. reconstituted magnetic fluid, and carrier gas at low pressure and temperature.

The object of using the converter is to produce as much electricity as possible. To achieve this objective, two of the most important factors that can be controlled when designing the converter are the density of the magnetic particles that pass through wire coils and the magnetic field strength provided to align the magnetic particles. As either or both of these parameters are increased, the amount of electricity induced in the coil will increase. High magnetic field and high magnetic particle density result in creation of a bullet that is semi-solid. The hysteresis property of magnetic materials keeps the bullet together such that, after exiting the coil, it continues towards the HDC as a semi-solid mass of material. If the hysteresis is not discharged rapidly enough and the particles comprising the bullets returned to the magnetic fluid state, the efficient continuous operation of the converter will be adversely affected and in all cases the semi-solid bullets traveling towards the HDC will cause physical damage to the conduits and valves of the converter and/or the system will become “plugged up” by the accumulation of masses of solid particles at critical places, e.g. at the exit of the HDC 102.

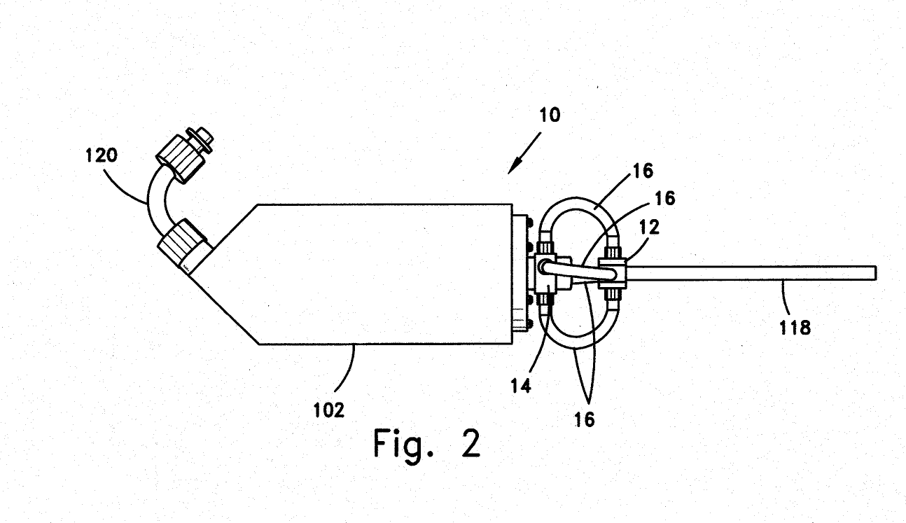

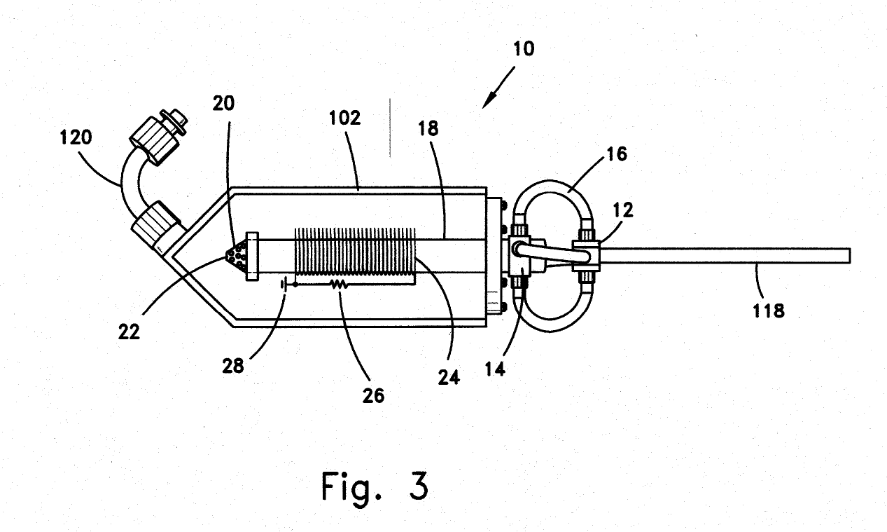

FIG. 2 and FIG. 3 schematically show the specially designed centrifuge of the present invention. Centrifuge 10 is to be inserted into conduit 118 of the converter immediately after coil 111. In FIG. 2 and FIG. 3, only the components of the converter illustrated in FIG. 1 that are essential to an understanding of the present invention are shown. In the embodiment shown centrifuge 10 is bolted to an open end of HDC 102 with part of centrifuge 10 outside of the HDC and a part inside of it. In FIG. 3 a part of the wall of HDC 102 has been removed to show the parts of centrifuge 10 that are inside of it.

In the section of conduit 118 after the location where electricity has been produced, a ferromixture comprised of high temperature and pressure carrier gas, vapor, and magnetic particles held together by hysteresis forces to form bullets. Conduit 118 connects to the top of upper manifold 12, a section of straight conduit (not clearly seen in the figures) connects the middle of the bottom of the top manifold to the middle of the top of the bottom manifold, and the bottom of lower manifold 14 is connected to the proximal end of tube 18 of centrifuge 10. It is to be noted that the inner diameter of tube 18 should be much larger than the inner diameter of conduit 118 in order to provide room for the particles that comprise the bullet to be dispersed as described herein. In upper manifold 12 part of the gaseous components of the ferromixture are diverted into shunts 16 (four are shown in this embodiment but more or less can be used), which lead to the lower manifold 14 while the bullets accompanied by a part of the carrier gas and vapor are carried straight ahead in conduit 118 by their momentum passing through the section of conduit connecting upper and lower manifolds into tube 18.

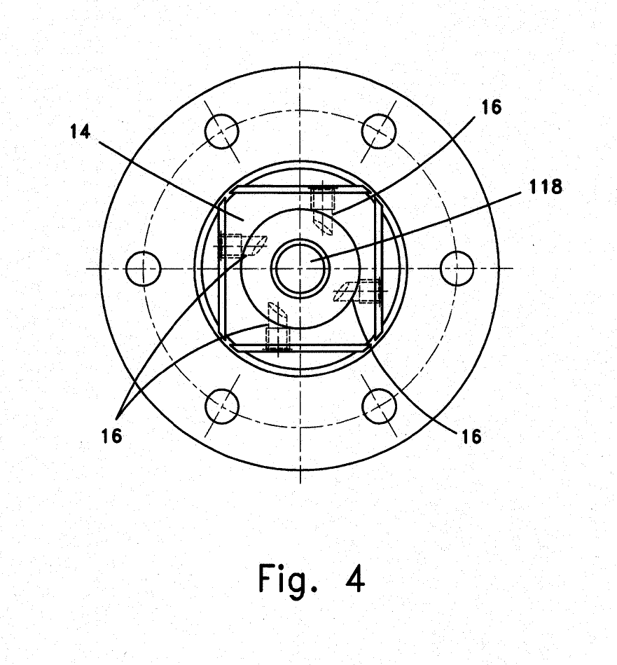

Referring now to FIG. 4, which shows a cross sectional view through the lower manifold 14, it can be seen that as the bullet, traveling through conduit 118, passes through the lower manifold it is struck on its sides by the gases that have traveled through shunts 16. The ends of shunts 16 enter the lower manifold “off-center” and at an angle as shown in the figure so that when the gas from each shunt impacts the sides of the bullet they impart forces that act to cause the bullet to spin. The exact angle at which the ends of shunts 16 should be oriented with relation to conduit 118 depends on several factors including the velocities of the bullet and gas traveling through the shunts. In an embodiment of the invention, the lower manifold 14 comprises a mechanism for changing this angle while the converter is operating in order to maximize the spin of the bullet.

As the bullet travels through tube 18 the spin that has been imparted to it creates the centrifugal forces that tend to increase the distance between the magnetic particles thereby weakening the magnetic force holding them together.

Finally the bullet is completely fragmented by striking the endpiece 20 of the centrifuge. Endpiece 20 has a truncated conical shape. The spinning bullet, which is forced to the side of tube 18, strikes the wall of endpiece 20 and breaks apart at which time the particles pass through a plurality of perforations in the wall of endpiece 20 while part of the gaseous component of the ferromixture passes through the open distal end. 22 of endpiece 20 of centrifuge 10 into HDC 102. Inside the cold HDC 102, the vapor condenses and the separated magnetic particles become suspended in it to form magnetic fluid. that accumulates at the distal end of the HDC.

It is noted that if a centrifuge 10 as described herein is placed in the converter, then valves 105 and 106 shown in FIG. 1 are optional. The function of valve 105 is fulfilled by the perforated wall of endpiece 20. If the end 22 of the endpiece of the centrifuge is close enough to the pool of magnetic fluid that has collected at the distal end of HDC 102 in the previous cycle, then the burst of gas exiting end 22 in the present cycle will form a pressure wave that pushes the magnetic fluid in the pool into conduit 120; thereby fulfilling the function of valve 106.

In an embodiment of the invention at least one wire, coil 24 is wrapped around tube 18. The magnetic field of the moving bullet induces an electric current in wire coil 24. The current passes through a resistive load 26, thereby further weakening the magnetic forces holding the magnetic particles in the bullet together. The electric energy generated at load 26 can be dissipated to ground 28 as shown or can be taken for internal use of the converter, e.g. to power the control system and/or electric valves. The description of the centrifuge herein above is provided as an example of the invention. Similar results can be obtained with other embodiments. For example in one embodiment the straight section of conduit between the upper and lower manifolds of the centrifuge can be blocked or removed. In this embodiment the gaseous components of the ferromixture and the bullets comprised of magnetic particles will flow from the upper manifold to the lower manifold through at least one shunt. If the lower manifold is adapted such that gas and bullets flowing through the at least one shunt enters it off-center and at an angle. Forces that act to cause the bullets to spin as they enter the large diameter tube will be created.

In another embodiment the shunts between the upper and lower manifolds of the centrifuge are removed or blocked and the straight section of conduit between the upper and lower manifolds of the centrifuge is replaced with a section of tubing bent into a spiral. In this embodiment causing the gaseous components of the ferromixture and the bullets comprised of magnetic particles to flow from the upper manifold to the lower manifold through the spiral shaped section of tube will impart forces that act to cause the bullets to spin as they enter the large diameter tube.

Although embodiments of the invention have been described by way of illustration, it will be understood that the invention may be carried out with many variations, modifications, and adaptations, without exceeding the scope of the claims.

1. A centrifuge for neutralizing hysteresis forces that hold magnetic particles of a magnetic fluid together in the form of bullets in a closed-circuit energy converter for converting thermal energy into alternating current electrical energy and for preventing damage to components or operation of the energy converter caused by the bullets, the energy converter comprising the following sections:
(i) a section wherein the magnetic fluid is decomposed into ferromixture comprising magnetic particles and gaseous components;
(ii) a section wherein the magnetic moments of the magnetic particles are aligned forming the magnetic particles into bullets that pass through coils of wire in which electricity is induced;
(iii) a section wherein the bullets are broken apart into individual magnetic particles having randomly oriented magnetic moments; and
(iv)a section wherein the magnetic fluid is recomposed from the magnetic particles and condensed gaseous components;
the centrifuge adapted to be inserted into a conduit in section (iii) of the energy converter and comprising:
(i) an upper manifold connected to the conduit of the energy converter;
(ii) a lower manifold;
(iii)at least one shunt and a section of straight conduit providing paths for components of ferromixture to travel from the upper manifold to the lower manifold; and
(iv) a large diameter tube having first and second ends, the first end connected to the bottom of the lower manifold and the second end connected to an endpiece, the endpiece having a truncated conical shape, a plurality of perforations in its wall, and an open distal end.

2. The centrifuge of claim 1, wherein the ends of the at least one shunt enter the lower manifold off-center and at an angle.

3. The centrifuge of claim 2, comprising a mechanism for changing the angle while the energy converter is working.

4. The centrifuge of claim 1, comprising at least one wire coil wrapped around the large diameter tube and connected to an electric circuit comprising a resistive load.

5. A method for neutralizing hysteresis forces that hold magnetic particles of a magnetic fluid together in the form of bullets in a closed-circuit energy converter for converting thermal energy into alternating current electrical energy and for preventing damage to components or operation of the energy converter caused by the bullets, the energy converter comprising the following sections:
(i) a section wherein the magnetic fluid is decomposed into ferromixture comprising magnetic particles and gaseous components;
(ii) a section wherein the magnetic moments of the magnetic particles are aligned forming the magnetic particles into bullets that pass through coils of wire in which electricity is induced;
(iii)a section wherein the bullets are broken apart into individual magnetic particles having randomly oriented magnetic moments; and
(iv)a section wherein the magnetic fluid is recomposed from the magnetic particles and condensed gaseous components;
the method comprising:
(a) inserting a centrifuge into a conduit in section (iii) of the energy converter; the centrifuge comprising:
(i) an upper manifold connected to the conduit of the energy converter;
(ii) a lower manifold;
(iii) at least one shunt and a section of straight conduit providing paths for components of ferromixture to travel from the upper manifold to the lower manifold; and
(iv) a large diameter tube having first and second ends, the first end connected to the bottom of the lower manifold and the second end connected to an endpiece, the endpiece having a truncated conical shape, a plurality of perforations in its wall, and an open distal end;
(b) causing a first part of the gaseous components of the ferromixture to flow from the upper manifold to the lower manifold through the at least one shunt;
(c) causing a second part of the gaseous components of the ferromixture and the bullets comprised of magnetic particles to flow from the upper manifold to the lower manifold through the section of straight conduit;
(d) adapting the lower manifold such that gas flowing through the at least one shunt impacts the sides of the bullets as they exit the section of straight conduit and pass through the center of the lower manifold, thereby imparting forces that act to cause the bullets to spin; and
(e) allowing the spinning bullets to continue to travel through the large diameter tube wherein the centrifugal forces on the spinning overcome the hysteresis forces that hold the magnetic particles together, thereby breaking apart the bullets;
wherein, the total amount of ferromixture that enters the upper manifold of the centrifuge is the same as the total amount of ferromixture that exits the centrifuge through the endpiece of the large diameter tube.

6. The method of claim 5 wherein the adapting step (d) comprises causing the ends of the at least one shunt enter the lower manifold off-center and at an angle.

7. The method of claim 6 wherein the angle is changed while the energy converter is working.

8. The method of claim 5 comprising wrapping at least one wire coil around the large diameter tube and connecting the coil to an electric circuit comprising a resistive load.

9. The method of claim 5 comprising:
(f) blocking or removing the straight section of conduit between the upper and lower manifolds of the centrifuge;
(g) replacing steps (b) and (c) with the step of causing the gaseous components of the ferromixture and the bullets comprised of magnetic particles to flow from the upper manifold to the lower manifold through the at least one shunt; and
(h) replacing step (d) with the step of adapting the lower manifold such that gas and bullets flowing through the at least one shunt enter the lower manifold off-center and at an angle thereby imparting forces that act to cause the bullets to spin as they enter the large diameter tube.

10. The method of claim 5 comprising:
(f) blocking or removing the at least one shunt between the upper and lower manifolds of the centrifuge;
(g) replacing the straight section of conduit between the upper and lower manifolds of the centrifuge with a section of tubing bent into a spiral shape;
(h) replacing steps (b), (c), and (d) with the step of causing the gaseous components of the ferromixture and the bullets comprised of magnetic particles to flow from the upper manifold to the lower manifold through the spiral shaped section of tube thereby imparting forces that act to cause the bullets to spin as they enter the large diameter tube.

11. An energy converter based on causing a magnetic fluid to travel around a closed circuit for converting thermal energy into alternating current electrical energy, the energy converter comprising at least one centrifuge adapted to neutralize hysteresis forces that hold magnetic particles in the magnetic fluid together in the form of bullets, thereby insuring efficient operation of the energy converter and preventing damage to components of the energy converter caused by the bullets.
